(19) United States
(12) Patent Application Publication
(10) Pub. No.: US 2019/0138125 A1
(43) Pub. Date: May 9, 2019

(54) DIFFERENTIAL FORCE SENSING REFERENCED TO DISPLAY

(71) Applicant: Synaptics Incorporated, San Jose, CA (US)

(72) Inventors: Henry Zeng, San Jose, CA (US); Igor Polishchuk, Fremont, CA (US)

(21) Appl. No.: 16/056,523

(22) Filed: Aug. 7, 2018

Related U.S. Application Data
(60) Provisional application No. 62/541,583, filed on Aug. 4, 2017.

(51) Int. Cl. G06F 3/044

(52) U.S. Cl. CPC G06F 3/044; G06F 3/04886; G06F 2203/04107; G06F 2203/04105

(57) ABSTRACT

An input device includes a display configured to bend in response to a force being applied by an input object to an input surface of the input device; a compressible layer, and a force sensor disposed below the display and separated from the display by the compressible layer, the force sensor comprising a first force sensing electrode. A first capacitance measurement, corresponding to the force, is obtained from the first force sensing electrode against a conductive layer of the display as a gap size between the conductive layer and the force sensing electrode changes when the display bends.

### CROSS REFERENCE TO RELATED APPLICATIONS

The present application claims priority under 35 U.S.C. § 119(e) to U.S. Provisional Application No. 62/541,583, filed on Aug. 4, 2017, having at least one of the same inventors as the present application, and entitled, “DIFFERENTIAL FORCE SENSING REFERENCED TO DISPLAY”. U.S. Provisional Application No. 62/541,583 is incorporated herein by reference.

### FIELD

This invention generally relates to electronic devices.

### BACKGROUND

Input devices, including proximity sensor devices (also commonly called touchpads or touch sensor devices), are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers). Proximity sensor devices are also often used in smaller computing systems (such as touch screens integrated in cellular phones).

### SUMMARY

In general, in one aspect, one or more embodiments relate to an input device. The input device includes a display configured to bend in response to a force being applied by an input object to an input surface of the input device; a compressible layer; and a force sensor disposed below the display and separated from the display by the compressible layer, the force sensor comprising a first force sensing electrode, wherein a first capacitance measurement, corresponding to the force, is obtained from the first force sensing electrode against a conductive layer of the display as a gap size between the conductive layer and the force sensing electrode changes when the display bends.

In general, in one aspect, one or more embodiments relate to an electronic system. The electronic system includes a housing; and an input device comprising: a display configured to bend in response to a force being applied by an input object to an input surface of the input device; a compressible layer; and a force sensor disposed below the display and separated from the display by the compressible layer, the force sensor comprising a first force sensing electrode, wherein a first capacitance measurement, corresponding to the force, is obtained from the first force sensing electrode against a conductive layer of the display as a gap size between the conductive layer and the force sensing electrode changes when the display bends.

Other aspects of the invention will be apparent from the following description and the appended claims.

### BRIEF DESCRIPTION OF DRAWINGS

One or more embodiments of the disclosure will hereinafter be described in conjunction with the appended drawings, where like designations denote like elements.

FIGS. 1, 2, and 3 are diagrams of example systems that includes an input device in accordance with one or more embodiments of the disclosure.

FIGS. 4A and 4B show results of using systems in accordance with one or more embodiments of the disclosure.

### DETAILED DESCRIPTION

The following detailed description is merely exemplary in nature, and is not intended to limit the invention or the application and uses of the invention. Furthermore, there is no intention to be bound by any expressed or implied theory presented in the preceding technical field, background, brief summary or the following detailed description.

In the following detailed description of embodiments of the disclosure, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Various embodiments of the present disclosure provide input devices and methods that facilitate improved usability. One or more embodiments are directed to an input device for a force sensor. The input device includes a bendable display screen. The bending of the display screen results from a force on an input surface of the display. One or more force sensing electrodes, disposed below the display screen, may measure the amount of force on the input surface, based on the bending of the display.

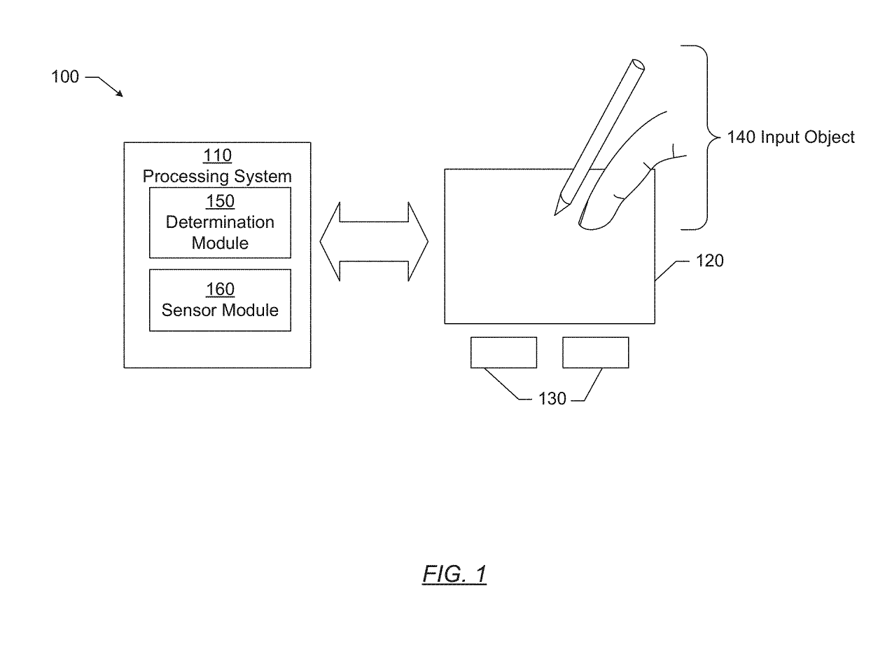

Turning now to the figures, FIGS. 1-3 are diagrams of example systems that includes an input device in accordance with one or more embodiments of the disclosure. The Figures are not drawn to scale. In particular, the relative sizes of the various components may change without departing from the scope of the disclosure. Further, although FIGS. 1-3 show a certain configuration of components, other configurations may exist without departing from the disclosure. For example, various components may be combined into a single component, a single component may be separated into multiple components, some components may not exist in an implementation, and other variations may occur.

FIG. 1 is a block diagram of an exemplary input device (100), in accordance with embodiments of the disclosure. The input device (100) may be configured to provide input to an electronic system (not shown). As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device (100) and separate joysticks or key switches. Further example electronic systems include peripherals, such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device (100) may be implemented as a physical part of the electronic system, or may be physically separate from the electronic system. Further, portions of the input device (100) may be part of the electronic system. For example, all or part of the determination module may be implemented in the device driver of the electronic system. As appropriate, the input device (100) may communicate with parts of the electronic system using any one or more of the following: buses, networks, and other wired or wireless interconnections. Examples include I2C, SPI, PS/2, Universal Serial Bus (USB), Bluetooth, RF, and IRDA.

In FIG. 1, the input device (100) is shown as a proximity sensor device (also often referred to as a “touchpad” or a “touch sensor device”) configured to sense input provided by one or more input objects (140) in a sensing region (120). Example input objects include fingers and styli, as shown in FIG. 1. Throughout the specification, the singular form of input object is used. Although the singular form is used, multiple input objects may exist in the sensing region (120). Further, which particular input objects are in the sensing region may change over the course of one or more gestures. To avoid unnecessarily complicating the description, the singular form of input object is used and refers to all of the above variations.

The sensing region (120) encompasses any space above, around, in and/or near the input device (100) in which the input device (100) is able to detect user input (e.g., user input provided by one or more input objects (140)). The sizes, shapes, and locations of particular sensing regions may vary widely from embodiment to embodiment.

In some embodiments, the sensing region (120) extends from a surface of the input device (100) in one or more directions into space until signal-to-noise ratios prevent sufficiently accurate object detection. The extension above the surface of the input device may be referred to as the above surface sensing region. The distance to which this sensing region (120) extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device (100), contact with an input surface (e.g. a touch surface) of the input device (100), contact with an input surface of the input device (100) coupled with some amount of applied force or pressure, and/or a combination thereof. In some embodiments, the input device (100) senses force applied in the sensing region (120). Further, in some embodiments, the input device (100) may sense touch, in addition to force. In various embodiments, input surfaces may be provided by surfaces of casings within which the sensor electrodes reside, by face sheets applied over the sensor electrodes or any casings, etc. In some embodiments, the sensing region (120) has a rectangular shape when projected onto an input surface of the input device (100).

The input device (100) may utilize any combination of sensor components and sensing technologies to detect user input in the sensing region (120). The input device (100) includes one or more sensing elements for detecting user input. As several non-limiting examples, the input device (100) may use capacitive, elastive, resistive, inductive, magnetic, acoustic, ultrasonic, and/or optical techniques.

Some implementations are configured to provide images that span one, two, three, or higher-dimensional spaces. Some implementations are configured to provide projections of input along particular axes or planes. Further, some implementations may be configured to provide a combination of one or more images and one or more projections.

In some resistive implementations of the input device (100), a flexible and conductive first layer is separated by one or more spacer elements from a conductive second layer. During operation, one or more voltage gradients are created across the layers. Pressing the flexible first layer may deflect it sufficiently to create electrical contact between the layers, resulting in voltage outputs reflective of the point(s) of contact between the layers. These voltage outputs may be used to determine positional information.

In some inductive implementations of the input device (100), one or more sensing elements pick up loop currents induced by a resonating coil or pair of coils. Some combination of the magnitude, phase, and frequency of the currents may then be used to determine positional information.

In some capacitive implementations of the input device (100), voltage or current is applied to create an electric field. Nearby input objects cause changes in the electric field and produce detectable changes in capacitive coupling that may be detected as changes in voltage, current, or the like.

Some capacitive implementations utilize arrays or other regular or irregular patterns of capacitive sensing elements to create electric fields. In some capacitive implementations, separate sensing elements may be ohmically shorted together to form larger sensor electrodes. Some capacitive implementations utilize resistive sheets, which may be uniformly resistive.

Some capacitive implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g., system ground), and by detecting the capacitive coupling between the sensor electrodes and input objects. The reference voltage may be a substantially constant voltage or a varying voltage and in various embodiments; the reference voltage may be system ground. Measurements acquired using absolute capacitance sensing methods may be referred to as absolute capacitive measurements.

Some capacitive implementations utilize “mutual capacitance” (or “trans capacitance”) sensing methods based on changes in the capacitive coupling between sensor electrodes. In various embodiments, an input object near the sensor electrodes alters the electric field between the sensor electrodes, thus changing the measured capacitive coupling. In one implementation, a mutual capacitance sensing method operates by detecting the capacitive coupling between one or more transmitter sensor electrodes (also “transmitter electrodes” or “transmitter”) and one or more receiver sensor electrodes (also “receiver electrodes” or “receiver”). Transmitter sensor electrodes may be modulated relative to a reference voltage (e.g., system ground) to transmit transmitter signals. Receiver sensor electrodes may be held substantially constant relative to the reference voltage to facilitate receipt of resulting signals. The reference voltage may be a substantially constant voltage and in various embodiments; the reference voltage may be system ground. In some embodiments, transmitter sensor electrodes may both be modulated. The transmitter electrodes are modulated relative to the receiver electrodes to transmit transmitter signals and to facilitate receipt of resulting signals. A resulting signal may include effect(s) corresponding to one or more transmitter signals, and/or to one or more sources of environmental interference (e.g., other electromagnetic signals). The effect(s) may be the transmitter signal, a change in the transmitter signal caused by one or more input objects and/or environmental interference, or other such effects. Sensor electrodes may be dedicated transmitters or receivers or may be configured to both transmit and receive. Measurements acquired using mutual capacitance sensing methods may be referred to as mutual capacitance measurements.

Further, the sensor electrodes may be of varying shapes and/or sizes. The same shapes and/or sizes of sensor electrodes may or may not be in the same groups. For example, in some embodiments, receiver electrodes may be of the same shapes and/or sizes while, in other embodiments, receiver electrodes may be varying shapes and/or sizes.

In FIG. 1, a processing system (110) is shown as part of the input device (100). The processing system (110) is configured to operate the hardware of the input device (100) to detect input in the sensing region (120). The processing system (110) includes parts of, or all of, one or more integrated circuits (ICs) and/or other circuitry components. For example, a processing system for a mutual capacitance sensor device may include transmitter circuitry configured to transmit signals with transmitter sensor electrodes, and/or receiver circuitry configured to receive signals with receiver sensor electrodes. Further, a processing system for an absolute capacitance sensor device may include driver circuitry configured to drive absolute capacitance signals onto sensor electrodes, and/or receiver circuitry configured to receive signals with those sensor electrodes. In one or more embodiments, a processing system for a combined mutual and absolute capacitance sensor device may include any combination of the above described mutual and absolute capacitance circuitry. In some embodiments, the processing system (110) also includes electronically-readable instructions, such as firmware code, software code, and/or the like. In some embodiments, components composing the processing system (110) are located together, such as near sensing element(s) of the input device (100). In other embodiments, components of processing system (110) are physically separate with one or more components close to the sensing element(s) of the input device (100), and one or more components elsewhere. For example, the input device (100) may be a peripheral coupled to a computing device, and the processing system (110) may include software configured to run on a central processing unit of the computing device and one or more ICs (perhaps with associated firmware) separate from the central processing unit. As another example, the input device (100) may be physically integrated in a mobile device, and the processing system (110) may include circuits and firmware that are part of a main processor of the mobile device. In some embodiments, the processing system (110) is dedicated to implementing the input device (100). In other embodiments, the processing system (110) also performs other functions, such as operating display screens, driving haptic actuators, etc.

The processing system (110) may be implemented as a set of modules that handle different functions of the processing system (110). Each module may include circuitry that is a part of the processing system (110), firmware, software, or a combination thereof. In various embodiments, different combinations of modules may be used. For example, as shown in FIG. 1, the processing system (110) may include a determination module (150) and a sensor module (160). The determination module (150) may include functionality to determine when at least one input object is in a sensing region, determine signal to noise ratio, determine positional information of an input object, identify a gesture, determine an action to perform based on the gesture, a combination of gestures or other information, and/or perform other operations.

The sensor module (160) may include functionality to drive the sensing elements to transmit transmitter signals and receive the resulting signals. For example, the sensor module (160) may include sensory circuitry that is coupled to the sensing elements. The sensor module (160) may include, for example, a transmitter module and a receiver module. The transmitter module may include transmitter circuitry that is coupled to a transmitting portion of the sensing elements. The receiver module may include receiver circuitry coupled to a receiving portion of the sensing elements and may include functionality to receive the resulting signals.

Although FIG. 1 shows only a determination module (150) and a sensor module (160), alternative or additional modules may exist in accordance with one or more embodiments of the disclosure. Such alternative or additional modules may correspond to distinct modules or sub-modules than one or more of the modules discussed above. Example alternative or additional modules include hardware operation modules for operating hardware such as sensor electrodes and display screens, data processing modules for processing data such as sensor signals and positional information, reporting modules for reporting information, and identification modules configured to identify gestures, such as mode changing gestures, and mode changing modules for changing operation modes. Further, the various modules may be combined in separate integrated circuits. For example, a first module may be comprised at least partially within a first integrated circuit and a separate module may be comprised at least partially within a second integrated circuit. Further, portions of a single module may span multiple integrated circuits. In some embodiments, the processing system as a whole may perform the operations of the various modules.

In some embodiments, the processing system (110) responds to user input (or lack of user input) in the sensing region (120) directly by causing one or more actions. Example actions include changing operation modes, as well as graphical user interface (GUI) actions such as cursor movement, selection, menu navigation, and other functions. In some embodiments, the processing system (110) provides information about the input (or lack of input) to some part of the electronic system (e.g. to a central processing system of the electronic system that is separate from the processing system (110), if such a separate central processing system exists). In some embodiments, some part of the electronic system processes information received from the processing system (110) to act on user input, such as to facilitate a full range of actions, including mode changing actions and GUI actions.

For example, in some embodiments, the processing system (110) operates the sensing element(s) of the input device (100) to produce electrical signals indicative of input (or lack of input) in the sensing region (120). The processing system (110) may perform any appropriate amount of processing on the electrical signals in producing the information provided to the electronic system. For example, the processing system (110) may digitize analog electrical signals obtained from the sensor electrodes. As another example, the processing system (110) may perform filtering or other signal conditioning. As yet another example, the processing system (110) may subtract or otherwise account for a baseline, such that the information reflects a difference between the electrical signals and the baseline. As yet further examples, the processing system (110) may determine positional information, recognize inputs as commands, recognize handwriting, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional”positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

In some embodiments, the input device (100) is implemented with additional input components that are operated by the processing system (110) or by some other processing system. These additional input components may provide redundant functionality for input in the sensing region (120), or some other functionality. FIG. 1 shows buttons (130) near the sensing region (120) that may be used to facilitate selection of items using the input device (100). Other types of additional input components include sliders, balls, wheels, switches, and the like. Conversely, in some embodiments, the input device (100) may be implemented with no other input components.

In some embodiments, the input device (100) includes a touch screen interface, and the sensing region (120) overlaps at least part of an active area of a display screen. For example, the input device (100) may include substantially transparent sensor electrodes overlaying the display screen and provide a touch screen interface for the associated electronic system. In some embodiments of the disclosure, the input device (100) includes one or more force sensing electrodes disposed below the display screen. The display screen may be any type of dynamic display capable of displaying a visual interface to a user and may include any type of light emitting diode (LED), organic LED (OLED), cathode ray tube (CRT), liquid crystal display (LCD), plasma, electroluminescence (EL), or other display technology. The input device (100) and the display screen may share physical elements. For example, some embodiments may utilize some of the same electrical components for displaying and sensing. In various embodiments, one or more display electrodes of a display device may be configured for both display updating and input sensing. As another example, the display screen may be operated in part or in total by the processing system (110).

It should be understood that while many embodiments of the disclosure are described in the context of a fully-functioning apparatus, the mechanisms of the present disclosure are capable of being distributed as a program product (e.g., software) in a variety of forms. For example, the mechanisms of the present disclosure may be implemented and distributed as a software program on information-bearing media that are readable by electronic processors (e.g., non-transitory computer-readable and/or recordable/writable information bearing media that is readable by the processing system (110)). Additionally, the embodiments of the present disclosure apply equally regardless of the particular type of medium used to carry out the distribution. For example, software instructions in the form of computer readable program code to perform embodiments of the disclosure may be stored, in whole or in part, temporarily or permanently, on a non-transitory computer-readable storage medium. Examples of non-transitory, electronically-readable media include various discs, physical memory, memory, memory sticks, memory cards, memory modules, and or any other computer readable storage medium. Electronically-readable media may be based on flash, optical, magnetic, holographic, or any other storage technology.

Although not shown in FIG. 1, the processing system, the input device, and/or the host system may include one or more computer processor(s), associated memory (e.g., random access memory (RAM), cache memory, flash memory, etc.), one or more storage device(s) (e.g., a hard disk, an optical drive such as a compact disk (CD) drive or digital versatile disk (DVD) drive, a flash memory stick, etc.), and numerous other elements and functionalities. The computer processor(s) may be an integrated circuit for processing instructions. For example, the computer processor(s) may be one or more cores or micro-cores of a processor. Further, one or more elements of one or more embodiments may be located at a remote location and connected to the other elements over a network. Further, embodiments of the disclosure may be implemented on a distributed system having several nodes, where each portion of the disclosure may be located on a different node within the distributed system. In one embodiment of the disclosure, the node corresponds to a distinct computing device. Alternatively, the node may correspond to a computer processor with associated physical memory. The node may alternatively correspond to a computer processor or micro-core of a computer processor with shared memory and/or resources.

While FIG. 1 shows a configuration of components, other configurations may be used without departing from the scope of the disclosure. For example, various components may be combined to create a single component. As another example, the functionality performed by a single component may be performed by two or more components.

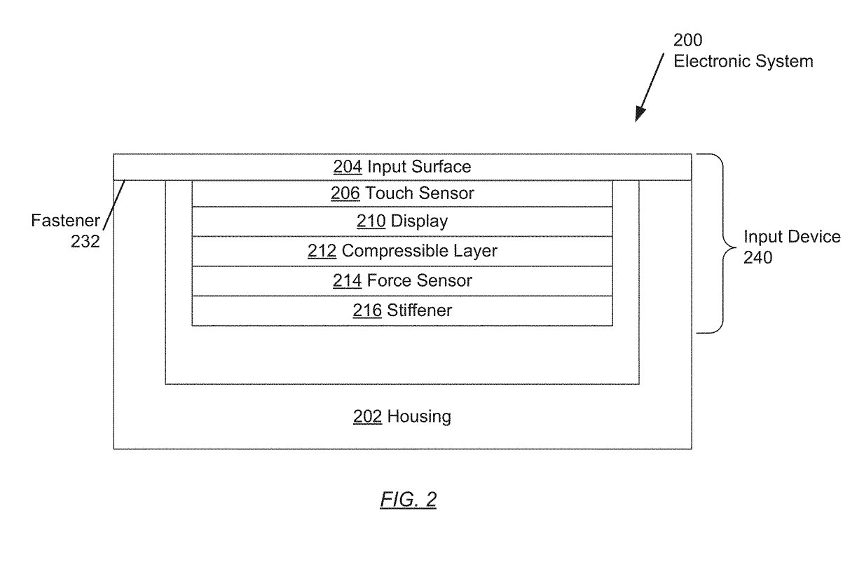

FIG. 2 shows a block diagram of an example system in accordance with one or more embodiments of the disclosure. In particular, FIG. 2 shows a cross section view of an electronic system (200) having an input device (240) in accordance with one or more embodiments of the disclosure. The electronic system may be a smart phone, a tablet computing device, a touchscreen, a computing device with a touchpad, or other device. As shown in FIG. 2, the electronic system (200) includes at least a housing (202) and an input device (240). The electronic system (200) may include additional components, such as a central processing unit, memory, controllers, and other components that are not shown.

The housing (202) may be metal, plastic, other material, or a combination of materials. The housing (202) may be referred to as the frame or mid-frame of the electronic system (200) and may hold the input device (240).

The input device (240) includes an input surface (204), a display (210), a compressible layer (212), a force sensor (214) and a stiffener (216). The input device may further include a touch sensor (206).

The input surface (204) is the surface of the input device (240) that may be touched by an input object. The input surface (204), in one embodiment of the invention, is a transparent cover of the display (210). For example, the input surface may be glass or another material.

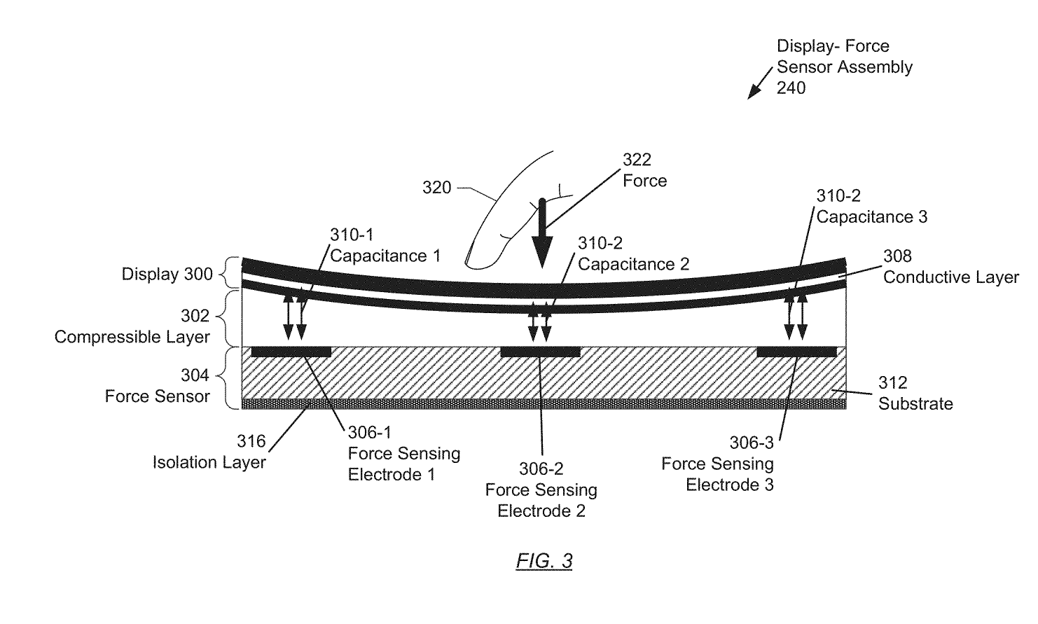

The display (206) is a physical device that is configured to present visual information to a user. The display may be any type of dynamic display capable of displaying a visual interface to a user and may include any type of light emitting diode (LED), organic LED (OLED), liquid crystal display (LCD), or other display technology. The input surface (204) and display (210) have bending properties that define the amount of bending by the input surface (204) and display (210) in response to force at various locations along input surface. In other words, the bending properties of the input surface (204) and display (210) is the amount of bend of the input surface (204) and display (210) when subjected to an external force onto the input surface (204) and display (210). The input surface (204) and display (210) may be treated as having a single bending properties or distinct bending properties. Although FIG. 3 shows a distinct input surface (204) and display (210), the input surface may be an uppermost part of the display.

The compressible layer (212) is a layer of the input device (240) that is configured to compress at least vertically in response to force applied to the input surface (204). In particular, the compressible layer may include one or more compressible materials. For example, the compressible layer (212) may include foam, an air gap, rubber, a soft adhesive such as silicone, or other compressible materials. The compressible layer may be a component of the display (210).

The force sensor (214) includes one or more force sensing electrodes that are configured to sense the amount of force applied by at least one input object. Capacitive sensing may be used to sense force. Accordingly, the capacitance measured by the force sensing electrode(s) is affected by the amount of force applied by an input object on the input surface. A detailed description of the force sensor (214) is provided below, with reference to FIG. 3.

In one or more embodiments, the stiffener (216) provides a rigid base for the force sensor (214). As described in detail below, the bending of the display (210) may thus be measured by the force sensor (214) which remains stationary (non-bending). The stiffener may be, for example, a metal, ceramic, fiber, polymer or composite material structure. A sufficient stiffness may be achieved by selection of a rigid material and/or by selection of a sufficient thickness of the stiffener. No dedicated stiffener (216) may be used if the force sensor (214) is placed on the housing (202). In this case, the housing (202) may serve as the stiffener (216).

A touch sensor (206) may be disposed between the input surface (204) and the display (210). The touch electrodes of the touch sensor are configured to detect the presence of the input object on or above the input surface. If the touch electrodes are capacitive electrodes, the capacitance measured using the touch electrodes is affected by the presence of at least one input object. Using the touch sensor (206), a presence, location and or motion of the input object(s) may be detected.

In one or more embodiments, the input surface (204), the touch sensor (206), the display (210), the compressible layer (212), the force sensor (214) and/or the stiffener (216) form a display-force sensor assembly, i.e., the input device (240). Adhesives or other means for mechanically attaching components may be used to join the components of the input device (240). The input device (240) may be pre-manufactured and may be installed in a device (e.g., the housing (202) of a smartphone), at a later time. A gap may exist between the stiffener (216) and the housing (202) after the installation of the input device (240) in the housing (202).

One or more fasteners (e.g., fastener (232)) may connect the input device (240) to the housing (202). For example, the fastener may be an adhesive (e.g., weld, solder, cement, glue), a crimping-style fastener, a mounting bracket or other hardware connector, or any other type of fastener. Other attachment points may exist without departing from the scope of the disclosure. The fastener may affect the bending properties of the of the input surface (204) and display (210). In other words, the amount of bend may change depending on the type of fasteners used and the location of the fasteners.

Turning to FIG. 3, a cross section of the input device (240), in accordance with one or more embodiments, is shown. In FIG. 3, an input object (320) exerts a force (322) on the input device (240). For simplicity, FIG. 3 omits certain components, e.g., the input surface (204), the touch sensor (206), the housing (202), etc. Accordingly, in FIG. 3, the input object (320) is shown as directly interacting with the display (300), resulting in a downward bending of the display.

In one or more embodiments, the display (300) includes one or more conductive layers (308). The conductive layer may be used as a force sensing reference, as described below. The conductive layer (308) may be, for example, an anode, a cathode, or a VCOM layer, i.e., an intrinsic component of the display (300) that is directly associated with the display's primary purpose of displaying content. Alternatively, the conductive layer may be a dedicated layer, added to the bottom of the display (not shown). This layer may be, for example, a laminated or printed metal film. Any conductive material that can be applied as a layer or film may be used, for example, silver, aluminum, copper, etc.

The force sensor (304), in accordance with one or more embodiments, includes a substrate (312) and one or more force sensing electrodes (306-1, 306-2, 306-3) disposed on the substrate (312). The substrate may be, for example, a printed circuit board (PCB). The substrate (312) may be equipped with an isolation layer (316). The isolation layer (316), in one embodiment, is configured to shield the force sensing electrodes (306-1, 306-2, 306-3) toward the bottom of the input device (240). The isolation layer may be tied to a ground signal or it may be driven as a shield. As a result, the force sensing electrodes (306-1, 306-2, 306-3) may obtain capacitance measurements in an upward direction, primarily. Alternatively, the stiffener (216) in FIG. 2, if made from a conductive material, may function as the isolation layer (316).

In one or more embodiments, the force sensing electrodes (306-1, 306-2, 306-3) are disposed on a top surface of the substrate (312). The electrodes may be patches of electrically conductive layers that are deposited on the substrate. Any number of electrodes may be placed on the substrate (312), using any geometric arrangement. While in FIG. 3 a cross-section is shown, those skilled in the art will recognize that the geometric arrangement of force sensing electrodes may extend in a second dimension.

In one or more embodiments, the capacitance (310-1, 310-2, 310-3) measurement by the force sensing electrodes (306-1, 306-2, 306-3) is performed toward the conductive layer (308). More specifically, the conductive layer (308) is at a certain electric potential. As a result, when a force sensing electrode is electrically driven, a capacitance between the force sensing electrode and the conductive layer may be measured. The capacitance may be governed by the distance between the force sensing electrodes and the conductive layer (308). A narrowing gap between a force sensing electrode (306-1, 306-2, 306-3) and the conductive layer (308) results in an increase of the associated capacitance (310-1, 310-2, 310-3), whereas a widening gap between the force sensing electrode (306-1, 306-2, 306-3) and the conductive layer (308) results in a decrease of the associated capacitance (310-1, 310-2, 310-3). Accordingly, with the force sensing electrodes (306-1, 306-2, 306-3) being stationary and the conductive layer (308) flexing when a force is applied, the capacitance measurements may be used to determine the force (322) being applied by the input object (320).

In one or more embodiments, the compressible layer (302) is the most compliant component, in comparison to the display (300) and the force sensor (304). In contrast, the force sensor (304), being supported by the stiffener (216 in FIG. 2), is a rigid component. Accordingly, one may assume that the force sensor (304) remains flat while the display (300) is bending when a force (322) is applied. Specifically, when a force is applied, the compressible layer (322) compresses, as illustrated in FIG. 3. The compression, thus, results in an increasing capacitance (310-1, 310-2, 310-3).

Depending on how the display (300) is mechanically supported, the central application of a force may also result in a peripheral widening of the gap between the display (300) and the force sensor (304) while resulting in a central narrowing of the gap. Accordingly, if multiple force sensing electrodes (306-1, 306-2, 306-3) are installed, centrally located electrodes may provide an increasing capacitance measurement, and peripherally located electrodes may provide a decreasing capacitance measurement.

In one or more embodiments of the disclosure, a differential measurement of the force is obtained based on measurements from a first force sensing electrode and a second force sensing electrode. Any method for obtaining a differential measurement may be used. For example, a capacitance measurement of a second force sensing electrode may be subtracted from a capacitance measurement of a first force sensing electrode. In such a scenario, the first force sensing electrode may be a centrally located force sensing electrode, and the second force sensing electrode may be a peripherally located force sensing electrode. This arrangement may not only increase the sensitivity of the obtained force measurement, but it may also make the force measurement less susceptible to common mode shifts resulting from, for example, temperature changes, aging of the sensor, wear, etc. Further, if a touch sensor (206) is included in the input device (240), the obtained location information may be used in conjunction with the force measurement. For example, depending on the location of the detected touch, force measurements from different force sensing electrodes may be added or subtracted and/or weighted. Further, an interpolation (e.g., a bi-linear interpolation) may be used to increase the accuracy and robustness of the force sensing.

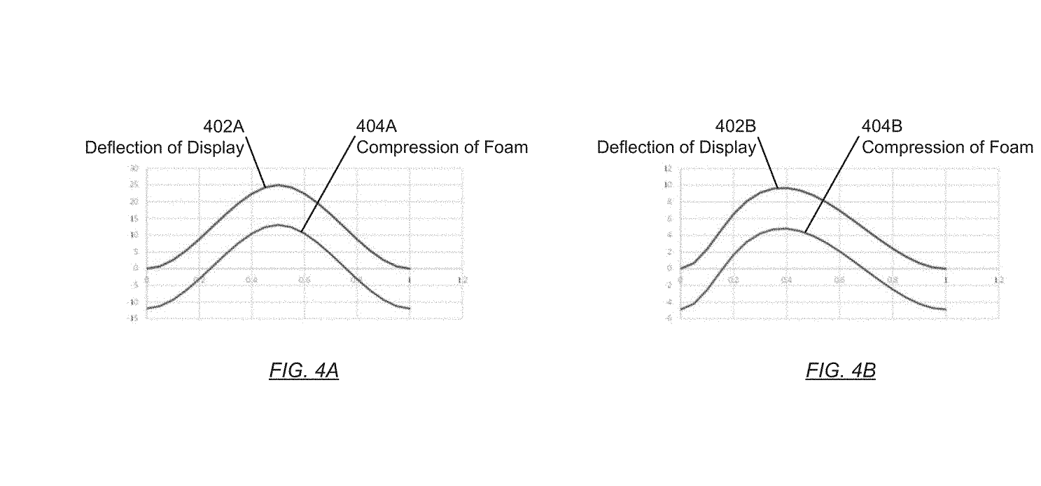

Turning to FIGS. 4A and 4B, results of using systems in accordance with one or more embodiments are shown.

Turning to FIG. 4A, a result of a centrally applied force is shown. A deflection of the display (402A) and a compression of a foam (404A) (i.e., the compressible layer) are shown. The deflection and the compression are shown in a positive y-axis direction, indicating a central deflection of the display, and an equal amount of central compression of the foam. Both the deflection and the compression symmetrically taper off toward the periphery of the display on which the force is applied.

Turning to FIG. 4B, a result of a non-centrally applied force is shown. A deflection of the display (402B) and a compression of the foam (404B) are shown. The result is a non-central deflection of the display, and an equal amount of non-central compression of the foam. Both the deflection and the compression asymmetrically taper off toward the periphery of the display on which the force is applied.

Because of the attachment of the input surface and the display to the housing, the amount of bending of the display at a location on the input surface is related to the distance from the attachment points to the location. For example, if the attachment points are around the edges of the input surface, then the display (300) may deflect less around the edges of the display (300) and deflect more towards the center of the display, as illustrated in FIGS. 4A and 4B. In other words, the bending properties may radiate inward toward the middle, whereby less bending is around the edges and more bending occurs toward middle when an equal amount of force is applied. In some instances, where additional or different attachment point(s) exist or other effects exist, the bending properties may be irregular.

In view of the results shown in FIGS. 4A and 4B, one may, thus, place multiple force sensing electrodes under the region that experiences deflection. These multiple force sensing electrodes, thus, capture different deflection amplitudes. Assume, for example, the force sensing electrode arrangement of FIG. 3. In this arrangement, in the example of the deflection shown in FIG. 4A, a central button press may be detected, whereas in the example of the deflection shown in FIG. 4B, a button press may be detected to the left of the center. Detection of the activation of such a virtual button may trigger a change of the content shown in the display. An entire two-dimensional grid of force sensing electrodes may be installed to measure forces over a 2D region.

As previously noted, the described force sensing may be performed by measuring capacitance or capacitances against a conductive layer of the display. No measurement against a midframe of the device or a dedicated conductive layer is necessary. Accordingly, the input device (240) is self-contained and may allow testing and/or calibration prior to installing the input device in a device.

Thus, the embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed.

What is claimed is:

1. An input device comprising:
a display configured to bend in response to a force being applied by an input object to an input surface of the input device;
a compressible layer; and
a force sensor disposed below the display and separated from the display by the compressible layer, the force sensor comprising a first force sensing electrode,
wherein a first capacitance measurement, corresponding to the force, is obtained from the first force sensing electrode against a conductive layer of the display as a gap size between the conductive layer and the force sensing electrode changes when the display bends.

2. The input device of claim 1, wherein the conductive layer is one selected from a group consisting of an anode, a cathode, and a VCOM layer of the display.

3. The input device of claim 1, wherein the conductive layer is deposited on the bottom of the display.

4. The input device of claim 1, wherein the force sensor comprises an isolation layer configured to shield the first force sensing electrode.

5. The input device of claim 1 further comprising a stiffener, providing a rigid base for the force sensor.

6. The input device of claim 1, wherein the input surface is a transparent cover of the display.

7. The input device of claim 1, further comprising a touch sensor configured to determine a location of the input object.

8. The input device of claim 1,
wherein the first force sensing electrode implements a virtual button, and
wherein activation of the virtual button updates content shown in the display.

9. The input device of claim 1 further comprising:
a second force sensing electrode,
wherein a second capacitance measurement, corresponding to the force, is obtained from the second force sensing electrode, and
wherein, when the force is applied, the gap size at the second force sensing electrode is different from the gap size at the first force sensing electrode.

10. The input device of claim 9, wherein a differential measurement of the force is obtained using the first and the second capacitance measurements.

11. The input device of claim 1, wherein the first force sensing electrode is one of a plurality of force sensing electrodes arranged in a two-dimensional grid.

12. An electronic system comprising:
a housing; and
an input device comprising:
a display configured to bend in response to a force being applied by an input object to an input surface of the input device;
a compressible layer; and
a force sensor disposed below the display and separated from the display by the compressible layer, the force sensor comprising a first force sensing electrode,
wherein a first capacitance measurement, corresponding to the force, is obtained from the first force sensing electrode against a conductive layer of the display as a gap size between the conductive layer and the force sensing electrode changes when the display bends.

13. The electronic system of claim 12, wherein the conductive layer is one selected from a group consisting of an anode, a cathode, and a VCOM layer of the display.

14. The electronic system of claim 12, wherein the conductive layer is deposited on the bottom of the display.

15. The electronic system of claim 12, wherein the force sensor comprises an isolation layer configured to shield the first force sensing electrode.

16. The electronic system of claim 12, wherein the input device further comprises a stiffener, providing a rigid base for the force sensor.

17. The electronic system of claim 12, wherein the input surface is a transparent cover of the display.

18. The electronic system of claim 12,
wherein the input device further comprises a second force sensing electrode,
wherein a second capacitance measurement, corresponding to the force, is obtained from the second force sensing electrode, and
wherein, when the force is applied, the gap size at the second force sensing electrode is different from the gap size at the first force sensing electrode.

19. The electronic system of claim 18, wherein a differential measurement of the force is obtained using the first and the second capacitance measurements.

20. The electronic system of claim 12, wherein the first force sensing electrode is one of a plurality of force sensing electrodes arranged in a two-dimensional grid.
